(19) United States
(12) Patent Application Publication
(10) Pub. No.: US 2010/0183938 A1
(43) Pub. Date: Jul. 22, 2010

(54) FUEL CELL

(76) Inventors: Masahiko IIjima, Saitama-ken (JP); Naoki Ito, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/668,040

(22) PCT Filed: Jul. 9, 2008
(86) PCT No.: PCT/IB08/01796

§ 371 Date: Jan. 7, 2010

(30) Foreign Application Priority Data
Jul. 13, 2007 (JP) 2007-184972

(51) Int. Cl. H01M 8/24; H01M 8/10

(52) U.S. Cl. 429/452; 429/479; 429/484; 429/497

(57) ABSTRACT

A fuel cell (100) includes: a fuel electrode (10) that is tubular in form and is made of a hydrogen permeable metal; a solid electrolyte membrane (20) that has proton conductivity and is formed on the fuel electrode; and an oxygen electrode (40) that is provided on the solid electrolyte membrane (20), and that is disposed opposite to the fuel electrode (10) across the solid electrolyte membrane (20).

### BACKGROUND OF THE INVENTION

1. Field of the Invention

The invention relates to fuel cells.

2. Description of the Related Art

Fuel cells are generally known as devices that yield electric energy by using hydrogen and oxygen as fuel. The fuel cells are environmentally excellent, and may achieve high energy efficiency. Therefore, the fuel cells are extensively being developed as a future energy supply system.

Among various types of fuel cells, solid electrolytes are used in polymer electrolyte fuel cells (PEFCs), solid oxide fuel cells (SOFCs), and others. Japanese Patent Application Publication No. 2005-150077 (JP-A-2005-150077) discloses a solid oxide fuel cell having a structure in which a fuel electrode and a solid electrolyte membrane are formed in cylindrical shape. The solid oxide fuel cell ensures certain strength owing to the cylindrical structure.

In the solid oxide fuel cell disclosed in JP-A-2005-150077, however, the cylindrical fuel electrode is formed of a porous, electrically conductive ceramic material, and it is thus difficult to provide the thin fuel electrode having adequate strength.

### SUMMARY OF THE INVENTION

The present invention provides a tubular fuel cell having a fuel electrode that may be formed with a small thickness while assuring adequate strength.

A fuel cell according to one aspect of the invention includes a fuel electrode that is formed with a tubular form and includes a hydrogen permeable metal, a solid electrolyte membrane that has proton conductivity and is formed on the fuel electrode, and an oxygen electrode that is provided on the solid electrolyte membrane, and that is disposed opposite to the fuel electrode across the solid electrolyte membrane.

In the fuel cell as described above, hydrogen in the form of protons may permeate through the fuel electrode, or hydrogen in the form of hydrogen atoms may permeate through the fuel electrode.

In the fuel cell according to the invention, the fuel electrode, which is tubular in form, has higher strength than a fuel cell of planar design. Also, since the fuel electrode is formed of metal, the fuel cell of the invention has high fracture toughness. Thus, in the fuel cell according to the invention, the fuel electrode may be formed with a small thickness (i.e., formed as a thin film) while assuring adequate strength.

The fuel electrode may be formed of a metal selected from the group consisting of at least palladium, vanadium, tantalum and niobium.

The fuel electrode may have a thickness of about 5 μm to 100 μm.

The fuel cell of the invention may further include a porous, base metal plate disposed radially inside the tubular fuel electrode for supporting the fuel electrode.

The solid electrolyte membrane may be formed on an outer circumferential surface of the tubular fuel electrode. In this case, the fuel electrode may be formed in the shape of a cylinder having no slits. As a result, the fracture toughness may be enhanced as compared with the case where metal having a slit or slits is used for forming the fuel electrode.

The fuel electrode may have a cylindrical shape.

The fuel electrode may be in the form of an elliptical tube.

The fuel electrode may be in the form of a rectangular tube.

The fuel electrode may be in the form of a flat tube.

The fuel cell may further include a collector that is formed on an outer circumferential surface of the fuel electrode and extends in a longitudinal direction of the fuel electrode.

An insulator may be provided between the collector and the oxygen electrode.

A plurality of fuel cells as described above may be stacked one another, and the collector in one fuel cell may be in contact with the oxygen electrode which is provided in an adjacent fuel cell.

An oxidizing gas channel is formed in a space that is surrounded by the stacked fuel cells.

The solid electrolyte membrane may be provided on a portion of the fuel electrode

The solid electrolyte membrane may be divided into a plurality of sections on the fuel electrode. In this case, stress that develops between the fuel electrode and the electrolyte membrane as the temperature increases is dispersed. As a result, the fuel electrode and electrolyte membrane are prevented from peeling off from each other.

A hydrogen leakage prevention member may be disposed in a clearance between adjacent solid electrolyte membranes that are divided into the plurality of sections.

The oxygen electrode may be formed radially inside the solid electrolyte membrane, and the fuel electrode may be formed radially outside the solid electrolyte membrane.

The fuel electrode has a flat surface; and the solid electrolyte membrane is formed on the flat surface of the fuel electrode. In this case, the electrolyte membrane and the fuel electrode are further prevented from peeling off from each other, as compared with the case where the electrolyte membrane is formed on a curved surface portion of the fuel electrode.

A first catalyst that promotes dissociation of hydrogen molecules into protons may be provided between the fuel electrode and the solid electrolyte membrane.

A second catalyst that promotes dissociation of hydrogen molecules into protons may be provided radially inside the fuel electrode such that the second catalyst is opposed to the first catalyst.

The second catalyst formed on the fuel electrode may have a larger area than the first catalyst.

In this case, the fuel electrode need not be entirely formed of a material having hydrogen conductivity and hydrogen dissociating capability, which leads to cost reduction. Also, where the area of the second catalyst is larger than that of the first catalyst, protons are supplied to the first catalyst with improved efficiency.

The fuel electrode may be formed of an element of the 5A group.

The first catalyst may contain palladium.

The first catalyst may contain an element selected from the group consisting of platinum, ruthenium and rhodium, and the first catalyst may have a porous structure.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1A and FIG. 1B schematically illustrate the structure of a fuel cell according to a first embodiment of the invention;

FIG. 2A and FIG. 2B illustrate the structure in which a plurality of fuel cells according to the first embodiment is stacked together in the vertical direction;

FIG. 3A through FIG. 3D depict examples of the cross-sectional shape of a fuel electrode;

FIG. 4A through FIG. 4C illustrate cross sections of a fuel cell in the longitudinal direction according to a second embodiment of the invention;

FIG. 5A and FIG. 5B schematically illustrate the structure of a fuel cell according to a third embodiment of the invention;

FIG. 6A and FIG. 6B schematically illustrate the structure of a fuel cell according to a fourth embodiment of the invention;

FIG. 7A and FIG. 7B schematically illustrate the structure of a fuel cell according to a fifth embodiment of the invention;

FIG. 8A and FIG. 8B schematically illustrate the structure of a fuel cell according to a sixth embodiment of the invention; and

FIG. 9 illustrates a schematic, cross-sectional structure of a fuel cell according to a seventh embodiment of the invention.

### DETAILED DESCRIPTION OF EMBODIMENTS

A plurality of embodiments of the invention will be described with reference to the drawings.

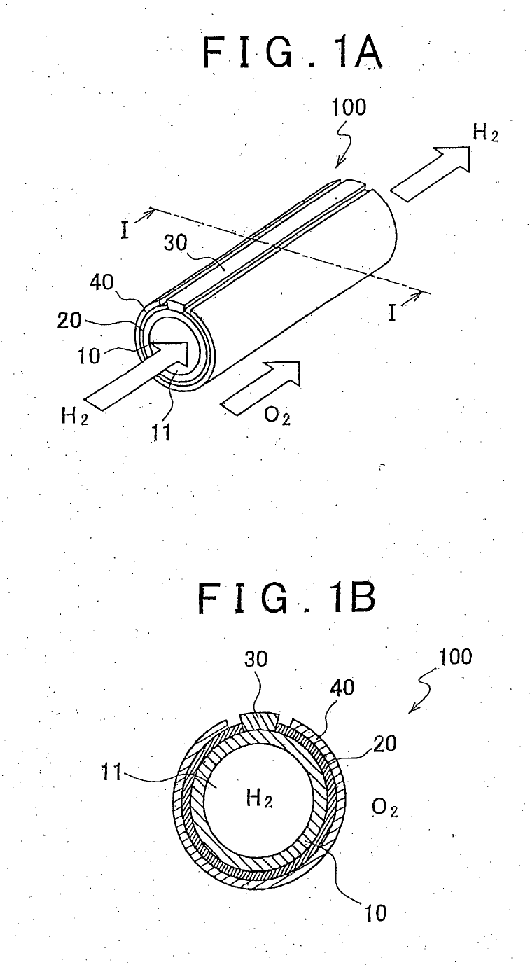

FIG. 1A and FIG. 1B schematically illustrate the structure of a fuel cell 100 according to a first embodiment of the invention. FIG. 1A is a schematic perspective view of the fuel cell 100. FIG. 1B is a cross-sectional view of the fuel cell 100 taken along line I-I in FIG. 1A. As shown in FIG. 1A and FIG. 1B, the fuel cell 100 includes a fuel electrode 10, an electrolyte membrane 20, a collector 30 and an oxygen electrode 40.

The fuel electrode 10 is composed of a dense hydrogen-permeable metal layer that is tubular or cylindrical in form. The space surrounded by the fuel electrode 10 functions as a fuel gas channel 11. The fuel electrode 10 of this embodiment has a dense structure through which hydrogen, in the form of hydrogen atoms and/or protons, may permeate. A material of which the fuel electrode 10 is formed is not particularly limited provided that it has a dense structure, hydrogen permeability and electrical conductivity.

For example, a metal, such as Pd (palladium), V (vanadium), Ta (tantalum), or Nb (niobium), an alloy of these metals, or the like, may be used for the fuel electrode 10. Also, a palladium alloy having a hydrogen dissociating capability, or the like, may be applied by coating to the opposite surfaces of the hydrogen permeable metal layer, to form the fuel electrode 10. The thickness of the fuel electrode 10 is not particularly limited, but may be about 5 μm to 100 μm. The diameter of the tubular fuel electrode 10 is not particularly limited, but may be several millimeters to several centimeters. The fuel electrode 10 may be supported by a porous, base metal plate provided on the inner side thereof.

The electrolyte membrane 20 and collector 30 are formed on the outer circumferential surface of the fuel electrode 10. Since the fuel electrode 10 has a dense structure in the first embodiment, the electrolyte membrane 20 may be formed with a sufficiently reduced thickness. Namely, it is possible to form the electrolyte membrane 20 in the form of a membrane or film without increasing the thickness of the electrolyte membrane 20. As a result, the membrane resistance of the electrolyte membrane 20 may be reduced.

A solid electrolyte that forms the electrolyte membrane 20 is not particularly limited provided that it has proton conductivity. For example, the electrolyte used for the electrolyte membrane 20 may be selected from a perovskite-type electrolyte (such as SrZrInO₃), pyrocblore-type electrolyte (Ln₂Zr₂O₇ (Ln: La (lanthanum), Nd (neodymium), Sm (samarium), etc.)), monazite-type rare earth orthophosphate electrolyte (LnPO₄ (Ln: La, Pr (praseodymium), Nd, Sm, etc.)), xenotime-type rare earth orthophosphate electrolyte (LnPO₄ (Ln: La, Pr, Nd, Sm, etc.)), rare earth metaphosphate electrolyte (LnP₃O₉ (Ln: La, Pr, Nd, Sm, etc.)), rare earth oxyphosphate electrolyte (Ln₇P₃O₁₈ (Ln: La, Pr, Nd, Sm, etc.)), and so forth.

The electrolyte membrane 20 may be formed on the outer circumferential surface of the fuel electrode 10 by, for example, a vapor-phase membrane forming method, a sol-gel method, or the like. For example, a PVD (physical vapor deposition) method, CVD (chemical vapor deposition) method, or the like, may be used as the vapor-phase membrane forming method. The PVD method may be selected from, for example, ion plating, pulsed-laser membrane forming method, sputtering, and so forth.

The collector 30 is formed of an electrically conductive material, such as silver. The electrolyte membrane 20 and collector 30 may cover the entire area of the outer circumferential surface of the fuel electrode 10. In this case, hydrogen that has passed through the fuel electrode 10 is prevented from leaking into an oxidizing gas channel (which will be described later). The collector 30 may extend in the longitudinal direction of the fuel electrode 10. In this case, the current collecting efficiency of the collector 30 is improved.

The oxygen electrode 40 is formed on the outer circumferential surface of the electrolyte membrane 20 so as not to contact with the collector 30. The oxygen electrode 40 is formed of an electrode material having catalytic activity and electrical conductivity. Here, the “catalytic activity” means the property of promoting reactions between oxygen, and electrons and protons. The oxygen electrode 40 is formed of, for example, an oxygen-ion-conducting ceramic (such as La_{0.6}Sr_{0.4}CoO₃, La_{0.5}Sr_{0.5}MnO₃, or La_{0.5}Sr_{0.5}FeO₃). The space being present outside the periphery of the oxygen electrode 40 functions as the above-mentioned oxidizing gas channel.

The oxygen electrode 40 may be formed on the outer circumferential surface of the electrolyte membrane 20 by, for example, a vapor-phase membrane forming method, sol-gel method, or the like, as is the case with the fuel electrode 10 as described above. For example, a PVD (physical vapor deposition) method, CVD (chemical vapor deposition) method, or the like, may be used as the vapor-phase membrane forming method. The PVD method may be selected from, for example, ion plating, pulsed-laser membrane forming method, sputtering, and so forth.

Next, the operation of the fuel cell 100 will be explained. Initially, fuel gas containing hydrogen is supplied to the fuel gas channel 11. The hydrogen contained in the fuel gas, which is in the form of protons and/or hydrogen atoms, permeates through the fuel electrode 10 composed of a hydrogen permeable metal layer. As a result, the hydrogen atoms and/or protons reach the electrolyte membrane 20. The hydrogen atoms that have reached the electrolyte membrane 20 are dissociated into protons and electrons at the interface between the fuel electrode 10 and the electrolyte membrane 20. Then, the protons are conducted through the electrolyte membrane 20, and reach the oxygen electrode 40.

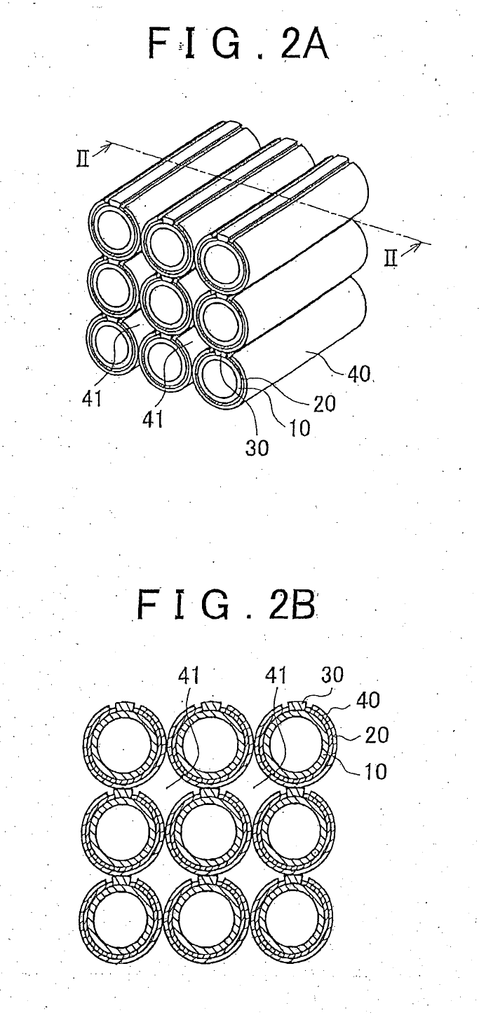

On the other hand, the oxidizing gas containing oxygen is supplied to the oxygen electrode 40 via oxidizing gas channels 41 (see FIG. 2B). The oxygen contained in the oxidizing gas reacts with the protons and electrons that have reached the oxygen electrode 40 at the interface between the oxygen electrode 40 and the electrolyte membrane 20, so that water is produced. At the same time, electric power is generated. In this manner, power generation is performed by the fuel cell 100. The electric power thus, generated is taken out of the fuel cell 100 via the fuel electrode 10 and the collector 30.

The fuel cell 100 of the first embodiment, which is tubular in form, has higher strength than a fuel cell of planar design. Also, since the fuel electrode 10 is formed of metal, the fuel cell 100 possesses high fracture toughness. In the fuel cell 100, therefore, the fuel electrode 10 may be formed as a thin membrane having a small thickness while assuring certain strength. Consequently, the size of the fuel cell 100 may be reduced. Also, since the fuel electrode 10 has a reduced thermal capacity, the energy required for starting the fuel cell 100 may be reduced. In the first embodiment, the fuel electrode 10 is formed radially inside the electrolyte membrane 20, and therefore, the fuel electrode 10 may be formed in the shape of a cylinder having no slits. In this case, the fracture toughness may be increased, as compared with the case where a metal having one or more slits is used for forming the fuel electrode 10.

Here, TABLE 1 as shown below indicates stress intensity factors (fracture toughness values) of typical metals and ceramics. As shown in TABLE 1, the metals have higher stress intensity factors than the ceramics. Similar relationships are obtained with respect to other metals and ceramics. Thus, the fuel cell 100 according to the first embodiment of the invention exhibits higher fracture toughness than widely used solid oxide fuel cells (SOFC) using fuel electrodes formed of ceramics.

TABLE 1
Stress Intensity Factor of Ceramic (room temperature)

| | | |
|---|---|---|
| Al₂O₃ | 3-5 | MPa · m^{1/2} |
| ZrO₂ (Electrolyte of SOFC) | 7-10 | MPa · m^{1/2} |

Stress Intensity Factor of Metal (room temperature)

| | | |
|---|---|---|
| SUS304L | 230 | MPa · m^{1/2} |
| V | 120 | MPa · m^{1/2} |

It may be proposed to form a polymer electrolyte fuel cell (PEFC) in tubular form. However, a fuel electrode of the PEFC, which is formed of an ionomer, carbon, or the like, is softer than the fuel electrode formed of metal. Accordingly, the PEFC cannot provide high strength if the thickness of the fuel electrode is reduced.

As described above, in the fuel cell 100 of this embodiment, the fuel electrode 10 may be formed as a thin film having a small thickness while assuring certain strength. With the thickness of the fuel electrode 10 thus reduced, the energy required for starting the fuel cell 100 is reduced. Furthermore, since the fuel electrode 10 takes the form of a dense metal layer, the thickness of the electrolyte membrane 20 formed on the fuel electrode 10 may be reduced. Consequently, the power generation efficiency of the fuel cell 100 is enhanced.

FIG. 2A and FIG. 2B illustrate a stacked structure in which a plurality of fuel cells 100 are stacked together in the vertical direction. FIG. 2A is a schematic perspective view of the stacked structure, and FIG. 2B is a cross-sectional view taken along line in FIG. 2A. As shown in FIG. 2A and FIG. 2B, the collector 30 of the lower one of two adjacent fuel cells 100 included in the stacked structure is in contact with the oxygen electrode 40 of the upper one of the fuel cells 100, when viewed in the vertical direction. With this arrangement, the fuel cells 100 are connected in series in the vertical direction, so that a high voltage may be obtained in power generation. On the other hand, the oxygen electrodes 40 of two adjacent fuel cells 100 included in the stacked structure are in contact with each other when viewed in the lateral direction. With this arrangement, the fuel cells 100 are connected in parallel with each other in the lateral direction, so that a large current may be obtained in power generation. A conductive adhesive, or the like, may be provided at each of contact portions of the fuel cells 100.

With a plurality of tubular fuel cells 100 thus arranged in the manner as described above, spaces surrounded by the respective oxygen electrodes 40 may be used as the oxidizing gas channels 41. In this case, no separators need be provided. Thus, the resulting fuel cell stack has a smaller thermal capacity than a fuel cell stack provided with separators. Consequently, the energy required for starting the fuel cells is reduced.

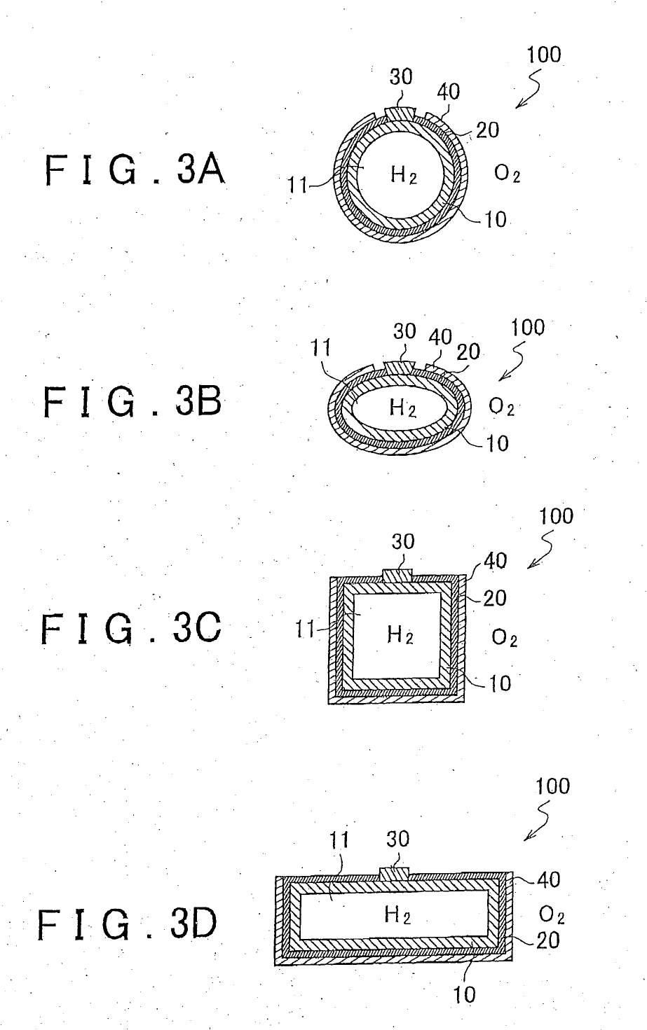

The cross-sectional shape of the fuel electrode 10 of the first embodiment is not particularly limited. FIG. 3A through FIG. 3D depict examples of the cross-sectional shape of the fuel electrode 10. As shown in FIG. 3A, the fuel electrode 10 may be circular in cross section. As shown in FIG. 3B, the fuel electrode 10 may be elliptical in cross section. As shown in FIG. 3C, the fuel electrode 10 may be rectangular in cross section. As shown in FIG. 3D, the fuel electrode 10 may be in the form of a flat tube that is rectangular in cross section.

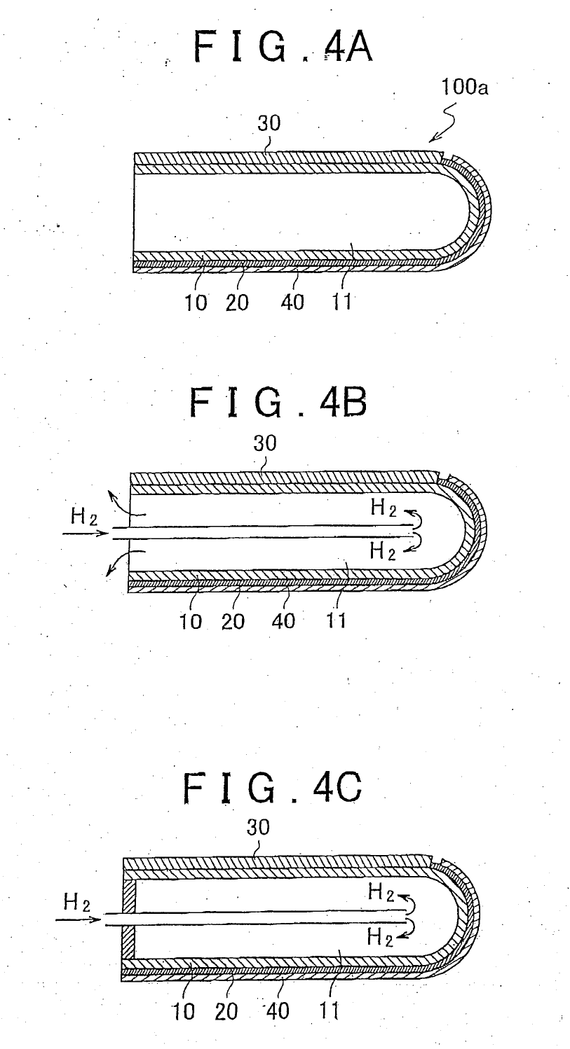

Next, a fuel cell 100a according to a second embodiment of the invention will be described. FIG. 4A illustrates a cross-section of the fuel cell 100a in the longitudinal direction. In the fuel cell 100a, one of the opposite ends of the fuel gas channel 11 is closed by the fuel electrode 10, electrolyte membrane 20 and the oxygen electrode 40.

In this case, the other end of the fuel gas channel 11 may be opened, as shown in FIG. 4B. In this case, hydrogen that has been supplied to the fuel gas channel 11 but has not been consumed is discharged from the other end of the fuel gas channel 11. The hydrogen thus discharged may be supplied to the fuel gas channel 11 again.

Since the electrolyte membrane 20 is a proton conductor in the second embodiment, no water is produced at the fuel electrode 10, and oxidizing gas components are prevented from being mixed into the fuel gas channel 11. Accordingly, the other end of the fuel gas channel 11 may be closed, as shown in FIG. 4C. In the arrangement of FIG. 4C, hydrogen supplied to the fuel gas channel 11 remains in the fuel gas channel 11 until it is consumed. In this case, there is no need to provide a means for circulating fuel gas.

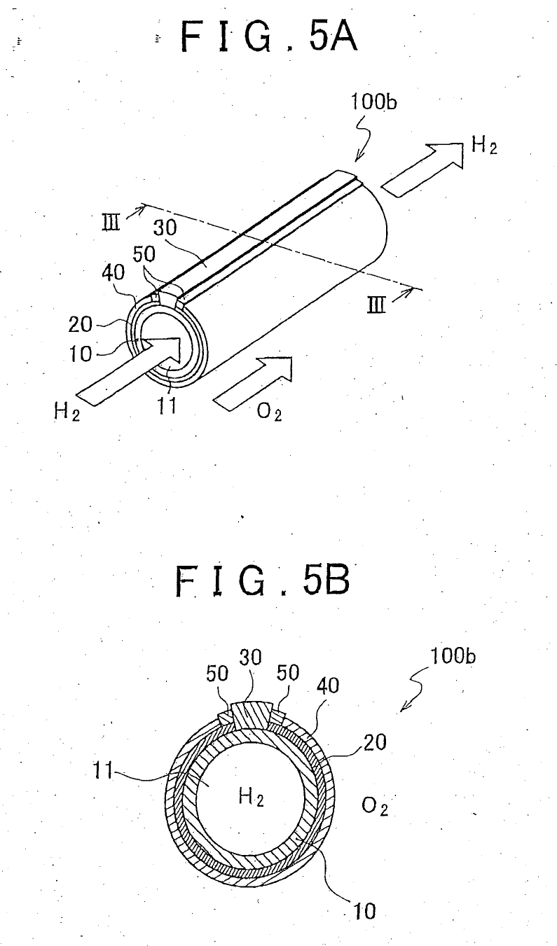

Referring next to FIG. 5A and FIG. 5B, a fuel cell 100b according to a third embodiment of the invention will be described. FIG. 5A is a schematic perspective view of the fuel cell 100b according to the third embodiment of the invention. FIG. 5B is a cross-sectional view taken along line in FIG. 5A. As shown in FIG. 5A and FIG. 5B, the fuel cell 100b is different from the fuel cell 100 of FIGS. 1A and 1B in that insulators 50 are further provided between the collector 30 and the oxygen electrode 40. In this case, the collector 30 and the oxygen electrode 40 are prevented from being short-circuited. As a result, a power generation failure is less likely to occur or is prevented from occurring in the fuel cell 100b. The insulators 50 may have sufficient durability at the operating temperature of the fuel cell 100b. For example, the insulators 50 are formed of a ceramic material.

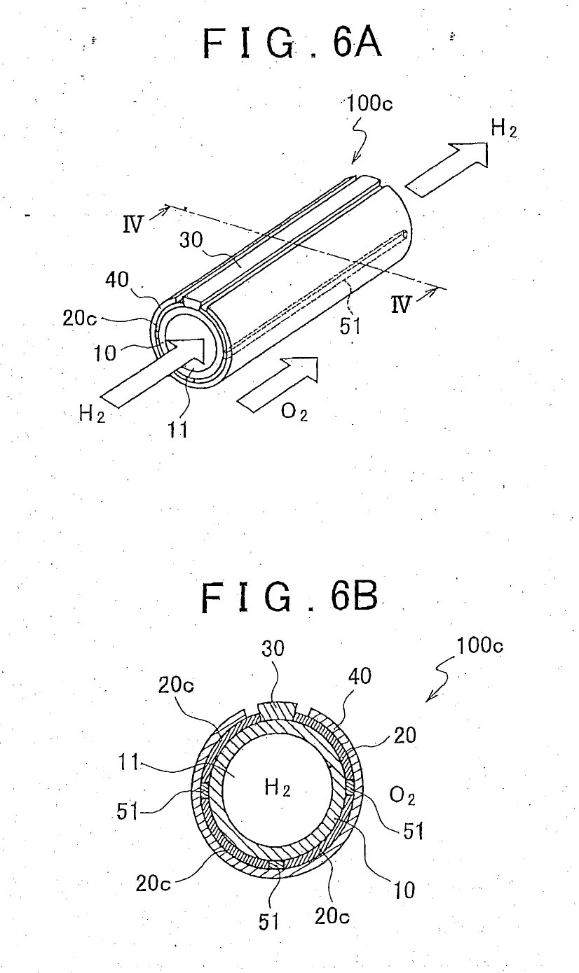

Referring next to FIG. 6A and FIG. 6B, a fuel cell 100c according to a fourth embodiment of the invention will be described. FIG. 6A is a schematic perspective view of the fuel cell 100c according to the fourth embodiment of the invention. FIG. 6B is a cross-sectional view taken along line IV-IV in FIG. 6A. As shown in FIG. 6A and FIG. 6B, the fuel cell 100c includes an electrolyte membrane 20c in place of the electrolyte membrane 20 of the fuel cell 100 of FIG. 1A and FIG. 1B. The electrolyte membrane 20c is formed of a material similar to that of the electrolyte membrane,20 of the first embodiment, and is divided into a plurality of sections on the fuel electrode 10.

Here, TABLE 2 as shown below indicates the coefficients of thermal expansion of typical metals and metal oxide. As shown in TABLE 2, there are differences between the coefficients of thermal expansion of the metals and the coefficient of thermal expansion of the metal oxide. Since the fuel electrode 10 is made of a metal and the electrolyte membrane 20 is made of a metal oxide in the first embodiment, it may be assumed that stress develops between the fuel electrode 10 and the electrolyte membrane 20 as the temperature increases. In the fourth embodiment, however, stress is dispersed since the electrolyte membrane 20c is divided into a plurality of sections. Consequently, the fuel electrode 10 and the electrolyte membrane 20c are further prevented from peeling off from each other.

TABLE 2
Coefficient of Thermal Expansion of Metal Oxide (room temperature)

| | |
|---|---|
| SrZr_{0.8}In_{0.2}O_{3 - δ} | 10 × 10⁻⁶/K |

Coefficient of Thermal Expansion of Metal (room temperature)

| | |
|---|---|
| Pd | 11 × 10⁻⁶/K |
| V | 8.3 × 10⁻⁶/K |

In view of a possibility of leakage of hydrogen through clearances between the sections of the electrolyte membrane 20, hydrogen leakage prevention members 51 may be disposed in the clearances of the electrolyte membrane 20. For example, the hydrogen leakage prevention members 51 are formed of a ceramic material.

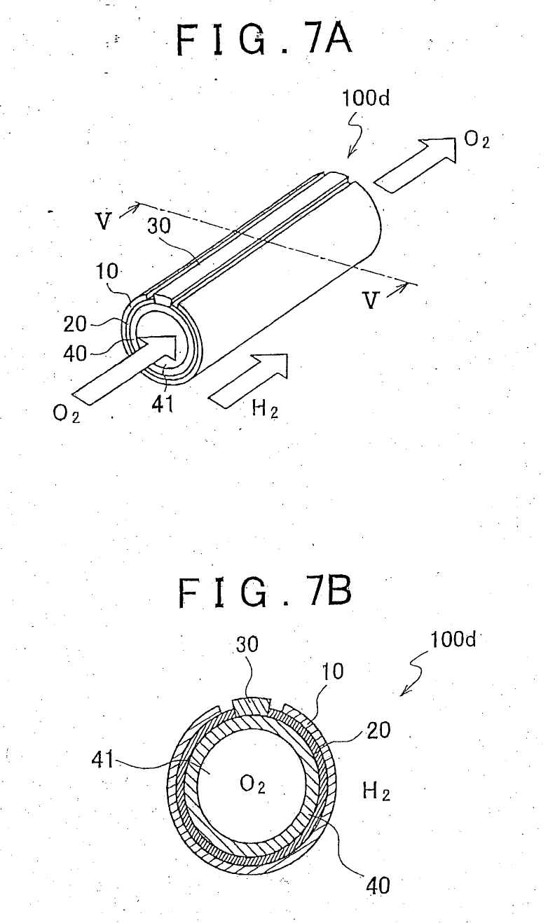

Referring next to FIG. 7A and FIG. 7B, a fuel cell 100d according to a fifth embodiment of the invention will be described. FIG. 7A is a schematic perspective view of the fuel cell 100d according to the fifth embodiment of the invention. FIG. 7B is a cross-sectional view taken along line V-V in FIG. 7A. As shown in FIG. 7A and FIG. 7B, the fuel cell 100d is different from the fuel cell 100 of FIG. 1A and FIG. 1B in that the oxygen electrode 40 is formed radially inside the electrolyte membrane 20, and the fuel electrode 10 is formed radially outside the electrolyte membrane 20. In this case, the space surrounded by the oxygen electrode 40 functions as the oxidizing gas channel 41. In the fifth embodiment, the collector 30 collects current from the oxygen electrode 40.

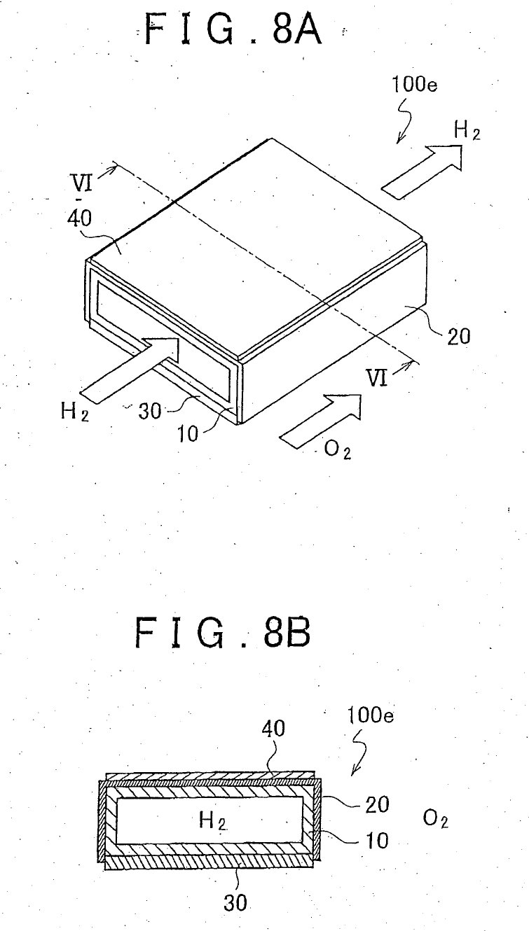

Referring next to FIG. 8A and FIG. 8B, a fuel cell 100e according to a sixth embodiment of the invention will be described. FIG. 8A is a schematic perspective view of the fuel cell 100e according to the sixth embodiment of the invention. FIG. 8B is a cross-sectional view taken along line VI-VI in FIG. 8A. As shown in FIG. 8A and FIG. 8B, the fuel cell 100e is different from the fuel cell 100 of FIG. 1A and FIG. 1B in that the fuel cell 100e is in the form of a flat tube that is rectangular in cross section.

In the sixth embodiment, the fuel electrode 10 has a flat, tube-like shape. The electrolyte membrane 20 is formed on a first flat surface of the fuel electrode 10. The oxygen electrode 40 is formed on the electrolyte membrane 20. The collector 30 is formed on a second flat surface of the fuel electrode 10. The second flat surface of the fuel electrode 10 is opposed to the first flat surface thereof.

In the sixth embodiment, the electrolyte membrane 20 is formed on a flat surface (i.e., first flat surface) of the fuel electrode 10. In this case, the electrolyte membrane. 20 and the fuel electrode 10 are further prevented from peeling off from each other, as compared with the case where the electrolyte membrane 20 is formed on a curved surface of the fuel electrode 10.

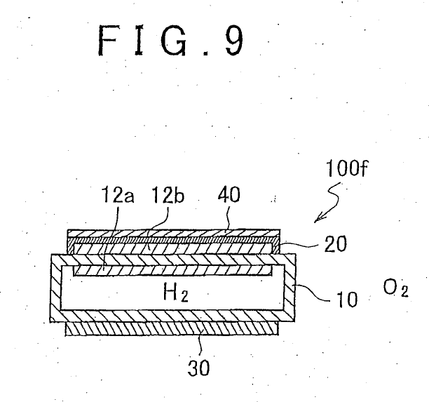

Referring next to FIG. 9, a fuel cell 100f according to a seventh embodiment of the invention will be described. FIG. 9 is a schematic perspective view of the fuel cell 100f. In the seventh embodiment, an element (such as V, Nb, or Ta) of the 5A group is used for forming the fuel electrode 10. In this case, the fuel cell 100f may be produced at reduced cost as compared with the case where a noble metal, such as Pd, is used. While the elements of the 5A group have hydrogen permeability, they are not able to dissociate hydrogen molecules into hydrogen atoms or protons, and are not able to form hydrogen molecules from hydrogen atoms or protons. Thus, catalysts 12a, 12b capable of dissociating hydrogen are provided on the inner and outer circumferential surfaces of the fuel electrode 10, respectively, as shown in FIG. 9.

The catalysts 12a, 12b are formed of, for example, Pd, Pd alloy, Pt. (platinum), Ru (ruthenium), Rh (rhodium),' etc. In this case, hydrogen flowing in the fuel gas channel 11 is dissociated at the catalyst 12a into hydrogen atoms or protons, which then pass through the fuel electrode 10 and the catalyst 12b. The hydrogen atoms that have reached the electrolyte membrane 20 are dissociated into protons and electrons at the interface between the catalyst 12b and the electrolyte membrane 20. Since Pd and Pd alloys have hydrogen permeability, the catalysts 12a, 12b made of Pd or Pd alloy may be in the form of layers. On the other hand, Pt, Ru, Rh, and the like, do not have hydrogen permeability, and therefore the catalysts 12a, 12b made of Pt, Ru, Rh, or the like, may be formed as porous structures.

If the catalyst 12b is provided in a region where the electrolyte membrane 20 is not formed, hydrogen may leak from that region. Accordingly, the catalyst 12b may be provided along a region where the electrolyte membrane 20 is formed. In the meantime, the area of the catalyst 12a may be larger than that of the catalyst 12b. In this case, protons are supplied to the catalyst 12b with improved efficiency. The catalyst 12a may be provided over the entire area of the inner circumferential surface of the fuel electrode 10. In this case, hydrogen atoms or protons pass through the whole fuel electrode 10, so that the hydrogen atoms or protons are supplied to the catalyst 12b with improved efficiency.

With the above arrangement, the amount of usage of a noble metal, such as Pd, in a portion that does not contribute to power generation may be reduced. Also, hydrogen is prevented from passing through the portion that does not contribute to power generation. As a result, leakage of hydrogen into the oxidizing gas channel may be suppressed or prevented.

While the catalysts 12a, 12b are provided in the fuel cell in the form of a flat tube in the seventh embodiment, the invention is not limited to this arrangement. For example, the catalysts 12a, 12b may be provided in other tubular fuel cells, such as that as shown in FIG. 1. In this case, too, the catalyst 12b may be provided along a region where the electrolyte membrane 20 is formed. The catalyst 12b may be regarded as “first catalyst” of the invention, and the catalyst 12a may be regarded as “second catalyst” of the invention.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A fuel cell, comprising:
a fuel electrode that is formed with a tubular form and includes a hydrogen permeable metal;
a solid electrolyte membrane that has proton conductivity and is provided on the fuel electrode; and
an oxygen electrode that is provided on the solid electrolyte membrane, and that is disposed opposite to the fuel electrode across the solid electrolyte membrane.

2. The fuel cell according to claim 1, wherein hydrogen in the form of protons permeates through the fuel electrode.

3. The fuel cell according to claim 1, wherein hydrogen in the form of hydrogen atoms permeates through the fuel electrode.

4. The fuel cell according to any one of claims 1 to 3, wherein the hydrogen permeable metal constituting the fuel electrode is selected from the group consisting of at least palladium, vanadium, tantalum and niobium.

5. The fuel cell according to any one of claims 1 to 4, wherein the fuel electrode has a thickness of about 5 μm to 100 μm.

6. The fuel cell according to any one of claims 1 to 5, further comprising a porous base metal plate that is disposed radially inside the tubular fuel electrode to support the fuel electrode.

7. The fuel cell according to any one of claims 1 to 6, wherein the solid electrolyte membrane is formed on an outer circumferential surface of the tubular fuel electrode.

8. The fuel cell according to any one of claims 1 to 7, wherein the fuel electrode has a cylindrical shape.

9. The fuel cell according to any one of claims 1 to 7, wherein the fuel electrode is formed with the form of an elliptical tube.

10. The fuel cell according to any one of claims 1 to 7, wherein the fuel electrode is formed with the form of a rectangular tube.

11. The fuel cell according to any one of claims 1 to 7, wherein the fuel electrode is formed with the form of a flat tube.

12. The fuel cell according to any one of claims 1 to 11, further comprising a collector that is formed on an outer circumferential surface of the fuel electrode and extends in a longitudinal direction of the fuel electrode.

13. The fuel cell according to claim 12, wherein an insulator is provided between the collector and the oxygen electrode.

14. The fuel cell according to claim 12, wherein:
a plurality of fuel cells is stacked one another; and
the collector in one fuel cell is in contact with the oxygen electrode that is provided in an adjacent fuel cell.

15. The fuel cell according to claim 14, wherein an oxidizing gas channel is formed in a space that is surrounded by the stacked fuel cells.

16. The fuel cell according to any one of claims 1 to 15, wherein the solid electrolyte membrane is provided on a portion of the fuel electrode.

17. The fuel cell according to claim 16, wherein the solid electrolyte membrane is divided into a plurality of sections on the fuel electrode.

18. The fuel cell according to claim 17, wherein a hydrogen leakage prevention member is disposed in a clearance between adjacent solid electrolyte membranes that are divided into the plurality of sections.

19. The fuel cell according to any one of claims 1 to 5, wherein:
the oxygen electrode is formed radially inside the solid electrolyte membrane; and
the fuel electrode is formed radially outside the solid electrolyte membrane.

20. The fuel cell according to claim 16, wherein:
the fuel electrode has a flat surface; and
the solid electrolyte membrane is formed on the flat surface of the fuel electrode.

21. The fuel cell according to any one of claims 2 to 20, wherein a first catalyst that promotes dissociation of hydrogen molecules into protons is provided between the fuel electrode and the solid electrolyte membrane.

22. The fuel cell according to claim 21, wherein a second catalyst that promotes dissociation of hydrogen molecules into protons is provided radially inside the fuel electrode such that the second catalyst is opposed to the first catalyst.

23. The fuel cell according to claim 22, wherein the second catalyst formed on the fuel electrode has a larger area than the first catalyst.

24. The fuel cell according to any one of claims 21 to 23, wherein the fuel electrode includes an element of the 5A group.

25. The fuel cell according to claim 21, wherein the first catalyst contains palladium.

26. The fuel cell according to claim 21, wherein:
the first catalyst contains an element selected from the group consisting of platinum, ruthenium and rhodium; and
the first catalyst has a porous structure.
